(19) United States
(12) Patent Application Publication
(10) Pub. No.: US 2020/0329744 A1
(43) Pub. Date: Oct. 22, 2020

(54) Bacon Product and Method of Production

(71) Applicant: Monogram Food Solutions, LLC, Memphis, TN (US)

(72) Inventors: Scott Mills, Memphis, TN (US); Tim Christopherson, Memphis, TN (US); Bill Southard, Memphis, TN (US); Vic Lovejoy, Memphis, TN (US); Tim Gurley, Memphis, TN (US)

(73) Assignee: Monogram Food Solutions, LLC, Memphis, TN (US)

(21) Appl. No.: 16/854,600

(22) Filed: Apr. 21, 2020

Related U.S. Application Data
(60) Provisional application No. 62/837,053, filed on Apr. 22, 2019.

(51) Int. Cl. A23L 5/10; A23L 13/00; A23P 10/22

(52) U.S. Cl. CPC A23L 5/10; A23P 10/22; A23L 13/00

(57) ABSTRACT

A method for producing a multi-slice bacon shingle is provided, comprising introducing a bulk meat product, such as a pork belly or other non-pork meat product, into a slicer; setting the slicer to control predetermined slicing parameters, namely blade speed, extent of overlap between adjacent bacon slices, and separation between successive bacon shingles; slicing the bulk meat product into bacon slices in accordance with the slicing parameters to produce a plurality of bacon shingles, wherein the adjacent bacon slices of each bacon shingle form a predetermined overlap between the adjacent bacon slices; and cooking the bacon shingles to a predetermined cook condition, wherein the adjacent bacon slices are caused to adhere to one another at the predetermined overlap.

### CROSS-REFERENCE TO RELATED APPLICATIONS

This nonprovisional application claims the benefit of priority under 35 USC § 119 to U.S. Application No. 62/837,053, filed on Apr. 22, 2019.

### BACKGROUND OF THE INVENTION

### 1. Field of the Invention

The present invention relates generally to methods of production for a bacon product suitable for use in sandwiches, and more particularly to such methods employed to form a multi-slice bacon shingle having a predetermined overlap between adjacent bacon slices that becomes fused during the cooking process. The bacon product can be partially pre-cooked or fully pre-cooked.

### 2. Description of Related Art

Various methods for producing bacon products have been developed over the years. In mass production environments, and particularly in the field of providing bacon for sandwiches, there are significant challenges to be overcome. Product assembly using bacon for breakfast sandwiches, sandwiches for other meals (such as bacon cheeseburgers), snacks (such as mini-bacon and chicken sandwiches), and placement of bacon atop an entree, has been traditionally slow and requires additional workers to keep up with assembly line speeds. Moreover, a key complaint from workers on the assembly operation and from consumers is missing bacon or too little bacon on sandwiches. There are at least four major issues with the traditional method of placing bacon slices on sandwiches, namely high labor costs, inferior finished products (such as sandwiches) due to missing or broken bacon, end-result finished product inconsistencies, and bacon waste. Product inconsistency is a major issue with retail packaged products, with one reason being that the product weights must be consistent with package label weight declarations. Inadequate weights in some states are a reason for mandatory product removal from the retail shelves. Also with foodservice and retail products, a business axiom is to have product consistency for the middle-man sellers (e.g., grocery stores, convenience stores, club stores, vending machines, mass merchants, and the like) and for end users (the consumers). When there is product inconsistency, there is a significant chance that sellers, buyers, and consumers will be disappointed in the finished product. These issues are attributable to several problems in the prior art.

Foremost among such problems is that the costs of assembly are high. In a typical sandwich, two separate slices of pre-cooked bacon need to be individually folded and placed on a moving sandwich during assembly, resulting in missing bacon due to faulty placement, folded pieces of bacon falling off the sandwich, and waste due to loss of broken pieces of bacon. Waste is a major undesirable expense with any food product, though especially with bacon, as pre-cooked bacon is an especially expensive meat product.

A possible solution to such problems is a single unit, or “shingle”, of multiple slices of bacon that are sliced to overlap and cook together during the cooking process to create a multi-slice bacon shingle that delivers the same amount of bacon that was previously delivered via two folded slices. Several benefits would be realized by such a solution. First, a multi-slice bacon shingle would result in increased throughput of assembly, i.e. one piece placement of a bacon shingle versus folding and placing two individual and potentially misshapen bacon pieces. Second, in a multi-slice bacon shingle as described herein, such as a 3-slice bacon shingle, there are three recognizable slices of bacon, which provides the quality appearance, taste, and bite of real slices. Third, the bacon shingle described and claimed herein results in even dispersion of bacon on the sandwich versus folded over bacon slices, meaning there is effectively greater coverage of the sandwich and bacon in every bite. Fourth, there would be improved assembly and reduced sandwich failure due to the flat fused bacon shingle being more stable during movement on the sandwich assembly line resulting in fewer sandwiches losing a bun top.

### SUMMARY OF THE INVENTION

In summary, the present invention is a method for producing a multi-slice bacon shingle, comprising introducing a bulk meat product (such as a pork belly or other non-pork product like turkey or other meat) into a slicer; setting the slicer to control predetermined slicing parameters, namely blade speed, extent of overlap between adjacent bacon slices, and separation between successive bacon shingles; slicing the pork belly into bacon slices in accordance with the slicing parameters to produce a plurality of bacon shingles, wherein the adjacent bacon slices of each bacon shingle form a predetermined overlap between the adjacent bacon slices; cooking the bacon shingles to a predetermined cook condition, wherein the adjacent bacon slices are caused to adhere to one another at the predetermined overlap.

Preferably, the predetermined slicing parameters are: (i) blade speed, (ii) number of actual slices in each bacon shingle, and (iii) number of denial slices for separation between the bacon shingles.

More preferably, to produce a 3-slice bacon shingle, the blade speed is 450 to 550 rpm; the number of actual slices is three; and the number of denial slices is four.

Prior to introducing the pork belly into the slicer, the method may further comprise the steps of cutting the pork belly longitudinally to create separate pork belly portions; and introducing the pork belly portions into the slicer in a side-by-side configuration, such that the slicer is able to cut the bacon slices from the pork belly portions in a single blade slice.

Prior to introducing the pork belly into the slicer, the method may further comprise the step of chilling the pork belly to an internal temperature between 24 F and 28 F.

Prior to introducing the pork belly into the slicer, the method may further comprise the step of smoking and curing the pork belly.

The method may further comprise the steps of placing the cooked bacon shingles onto packaging sheets; layering a plurality of packaging sheets containing the bacon shingles into a sealable container; and purging the container of air to an oxygen content of two percent or less.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 illustrates a flowchart of steps for a preferred embodiment of the invention.

FIG. 2 illustrates a schematic diagram showing equipment used in a preferred embodiment of the invention.

FIG. 3 illustrates views of a bacon shingle produced in accordance with a preferred embodiment of the invention.

FIG. 4 illustrates an example of a bacon shingle in the process of production prior to cooking in accordance with a preferred embodiment of the invention.

FIG. 5 illustrates bacon shingles produced in accordance with a preferred embodiment of the invention being placed on a sandwich.

### DETAILED DESCRIPTION OF THE PREFERRED EMBODIMENTS

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed. In addition, a specific scale of operation is described as the current illustrative embodiment; however, the scale can be increased or decreased by simply adjusting the size of the various parts of the apparatus as will be apparent to one of skill in the art, and no limitation of the scale of operation is intended by this specification.

In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “having,” “containing,” “characterized by,” and grammatical equivalents thereof are inclusive or open-ended terms that do not exclude additional, unrecited elements or method steps.

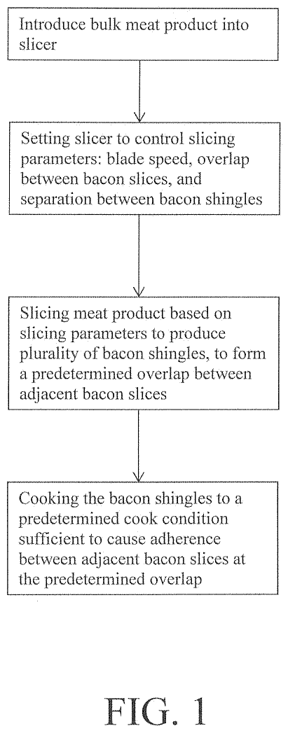

With reference to a preferred embodiment of the invention shown in FIGS. 1-5, a method for producing a multi-slice bacon product 1 is described. Pork bellies 2 are boneless cuts of fatty meat from the belly of a pig, and they are generally flat and rectangular in shape, having two long sides and two short sides. For purposes of the present invention, the size of the pork bellies 2 are optimally in the range of 11/13 and 13/15 pound sizes, although other sizes can be similarly processed with equivalent results. Prior to slicing, the pork bellies 2 are preferably smoked, cured, and chilled in a conventional manner. More preferably, the pork bellies 2 are trimmed along their long sides so as to remove excess fatty portions, and such that the pork belly 2 has a width of approximately eight inches (8″).

While the preferred embodiment of the invention refers mainly to real pork bacon using pork bellies as a feed stock, it should be understood that the methods described and claimed herein can be similarly applied to non-pork products, such as a bulk meat products including formed turkey or other meats, to produce sliced “turkey bacon” and similar bacon-type products.

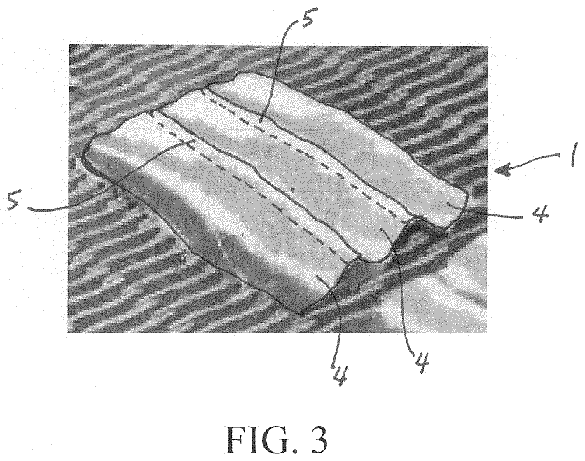

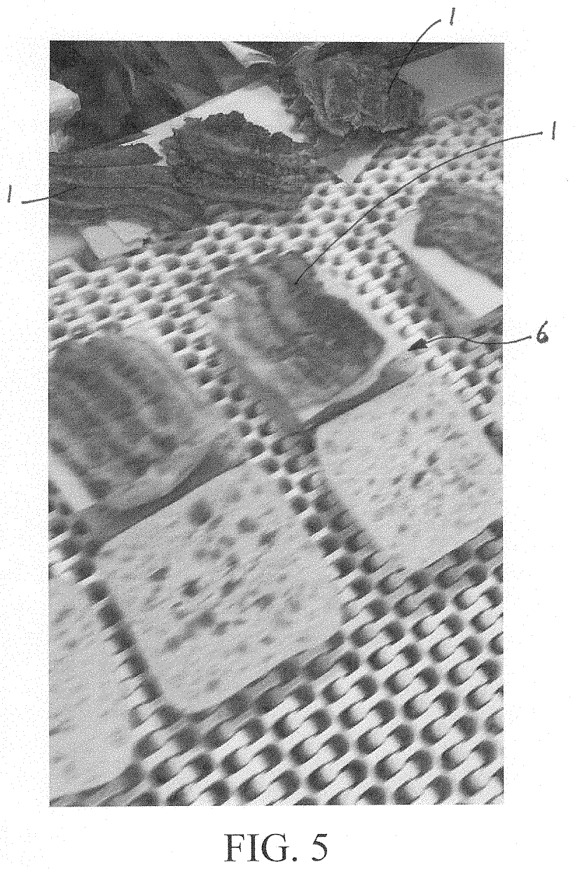

In a preferred embodiment, one objective is to produce a bacon “shingle” 1, which is preferably a composite of three generally parallel and overlapping bacon slices 4 which is about four inches (4″) along the length of the bacon slices 4 and about three inches (3″) across the bacon shingle 1, as shown in FIG. 3. Another objective is to cause the adjacent bacon slices 4 in the shingle to “fuse”, or adhere, to one another at their overlapping areas 5 (shown in hidden lines) during the cooking step. In this manner, the final cooked bacon shingle 1 can easily be handled manually by assembly line workers and placed on a sandwich 6, such as a breakfast sandwich or similar product, as shown in FIG. 5.

In order to produce a bacon shingle 1 of the aforementioned size, proportions, and characteristics, it is necessary to feed the input of the slicer 3 with a portion of pork belly 2 that results in bacon slices 4 that are approximately four inches (4″) long. Therefore, prior to being fed into the slicer 3, each pork belly 2, trimmed along its long sides as described above, is cut longitudinally, i.e. in a direction parallel to the long sides of the pork belly 2, into two separate and roughly equal halves. After the longitudinal cut, each pork belly 2 half is approximately four inches (4″) wide, enabling bacon slices 4 of the same width. The pork belly 2 halves are preferably chilled to a suitable slicing temperature, which is generally an internal temperature between about 24° F. and 28° F. If other non-pork meat products are used as a feed stock, the non-pork meat product may be pre-cut or pre-formed having the desired width, eliminating or minimizing the step of the longitudinal cut.

The pork belly 2 halves are then introduced into an input area 7, or receiving conveyor, of the slicer 3. The slicer 3 may be any slicer capable of producing a precooked bacon shingle 1 in the manner described herein, such as a Thurne IBS4600 precooked bacon slicer, although other slicers having similar functionality may also be used. The pork belly 2 halves are inserted into the slicer 3 in a parallel side-by-side configuration, but horizontally separated from one another by about two inches to five inches (2″-5″) so that precooked bacon shingles 1 exiting the slicer 3 are suitably separated. When the pork belly 2 halves are fed into the slicer 3 in this manner, the slicer 3 is able to simultaneously cut bacon slices 4 from both pork belly 2 halves in a single blade slice, resulting in two bacon slices 4 that are each about four inches (4″) long.

In advance of the actual slicing operation, the slicer settings are adjusted to control predetermined slicing parameters for the purposes of establishing the desired overlap 5 of the bacon slices 4 for each multi-slice bacon shingle 1, and creating the desired separation between each successive bacon shingle 1. For example, in the Thurne IBS4600 slicer referred to above, the following parameters are set: (i) blade speed, which determines the thickness and amount of overlap 5 between the bacon slices 4, (ii) the number of actual slices (cuts of the blade) necessary to create a bacon shingle 1, and (iii) the number of denial slices necessary to create the desired separation between the bacon shingles 1 as they exit the slicer 3. In a preferred method, the blade speed is set between 450 rpm to 550 rpm, with an optimal blade speed of about 500 rpm. For a 3-slice bacon shingle 1, the number of actual slices is set to three. The number of denial slices, which is the number of revolutions of the blade resulting in no actual slice being made is preferably set to four, allowing the previously sliced bacon shingle 1 to move away from the blade, and resulting in a suitable separation from the next bacon shingle 1. It should be understood that such settings can be adjusted to produce bacon shingles 1 with a range of slices 4 to produce smaller or larger bacon shingles 1, such as 2-slice shingles, 4-slice shingles, and others as desired. Furthermore, if a slicer other than the Thurne IBS4600 slicer is used, such as slicers operating differently by causing the input conveyor to stop, decelerate, and accelerate during the slicing step, then the appropriate settings for such slicers can be adjusted to establish the desired bacon slice overlap and separation between the bacon shingles.

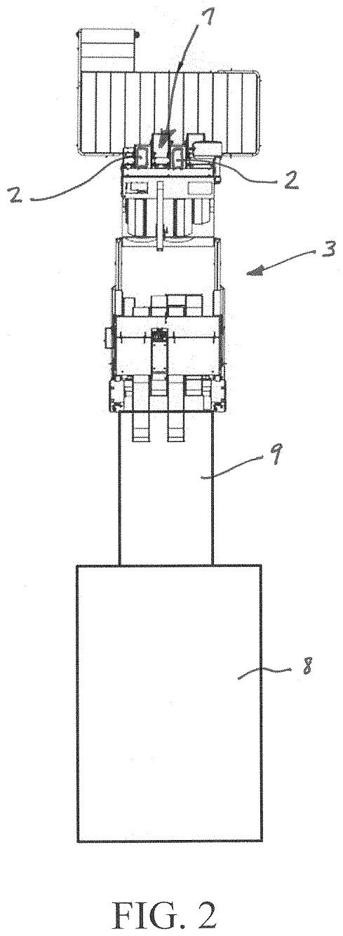

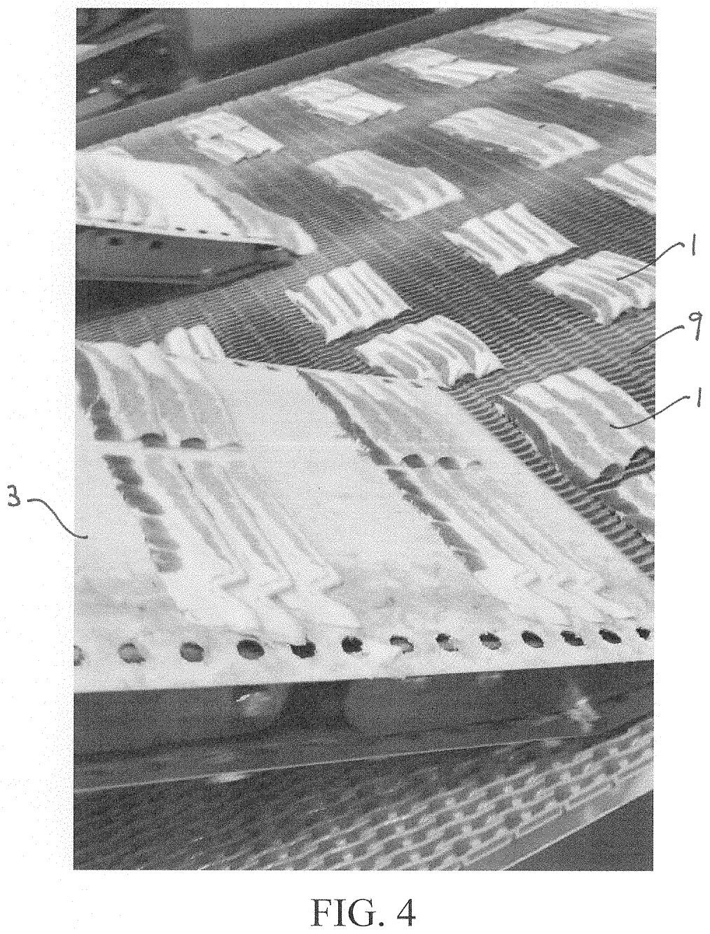

Pursuant to the above slicer parameter settings, the pork belly 2 halves are then fed through the slicer 3, and successive precooked bacon shingles 1 are created having the features shown in FIGS. 3 and 4. With respect to the slicer shown in FIGS. 2 and 4, up to four lanes of bacon shingles 1 can be produced simultaneously. For example, to produce four lanes of bacon shingles 1, each of the four input conveyors 7 for the slicer 3 are loaded with two side-by-side pork belly 2 halves as explained previously, for a total of eight pork belly 2 halves. As the pork bellies 2 are sliced, the input conveyors 7 can be loaded with additional pork belly 2 halves to create a substantially continuous production process.

As the precooked bacon shingles 1 are conveyed from the slicer 3, the bacon shingles 1 are transferred by the conveyor 9 to the cooking equipment 8, which is typically a microwave oven, where they are cooked to a predetermined cook condition. During the cooking step, the bacon slices 4 are heated such that the fat at the predetermined overlapping areas 5 between adjacent bacon slices 4 becomes partially melted. As the cooked bacon shingles 1 exit the oven, the bacon shingles 1 are cooled, causing the fat to congeal and a corresponding adherence, or fusing, of the adjacent bacon slices 4 to one another at the overlapping areas 5.

The resulting bacon shingles 1 may then be packaged in ready-to-eat form by placing the cooked bacon shingles onto packaging sheets, layering a plurality of packaging sheets containing the bacon shingles into a sealable container, and purging the container of air to an oxygen content of two percent or less. For example, in a preferred embodiment, a batch of 3-slice bacon shingles may be placed on 8.5″×14″ paper sheets in sets of eight shingles per sheet, and typically twenty (20) sheets of shingles may be inserted into the sealable container or pouch, while eight pouches may be placed within a larger packaging box for shipment to retail customers or sandwich assembly facilities.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only, and the scope of the present invention is to be limited only by the following claims.

The invention claimed is:

1. A method for producing a multi-slice bacon shingle, comprising:
(a) introducing a bulk meat product into a slicer;
(b) setting the slicer to control predetermined slicing parameters, namely blade speed, extent of overlap between adjacent bacon slices, and separation between successive bacon shingles;
(c) slicing the bulk meat product into bacon slices in accordance with the slicing parameters to produce a plurality of bacon shingles, wherein the adjacent bacon slices of each bacon shingle form a predetermined overlap between the adjacent bacon slices; and
(d) cooking the bacon shingles to a predetermined cook condition, wherein the adjacent bacon slices are caused to adhere to one another at the predetermined overlap.

2. The method of claim 1, wherein the predetermined slicing parameters are: (i) blade speed, (ii) number of actual slices in each bacon shingle, and (iii) number of denial slices for separation between the bacon shingles.

3. The method of claim 2, wherein:
(a) the blade speed is 450 to 550 rpm;
(b) the number of actual slices is three; and
(c) the number of denial slices is four.

4. The method of claim 1, wherein the bulk meat product is pork belly.

5. The method of claim 1, wherein the bulk meat product is a non-pork meat product.

6. The method of claim 4, prior to introducing the pork belly into the slicer, further comprising the steps of:
(a) cutting the pork belly longitudinally to create separate pork belly portions; and
(b) introducing the pork belly portions into the slicer in a side-by-side configuration, such that the slicer is able to cut the bacon slices from the pork belly portions in a single blade slice.

7. The method of claim 4, prior to introducing the pork belly into the slicer, further comprising the step of chilling the pork belly to an internal temperature between 24 F and 28 F.

8. The method of claim 1, prior to introducing the bulk meat product into the slicer, further comprising the step of smoking and curing the bulk meat product.

9. The method of claim 1, further comprising the steps of:
(a) placing the cooked bacon shingles onto packaging sheets;
(b) layering a plurality of packaging sheets containing the bacon shingles into a sealable container; and
(c) purging the container of air to an oxygen content of two percent or less.
